(19) United States
(12) Patent Application Publication
(10) Pub. No.: US 2009/0009355 A1
(43) Pub. Date: Jan. 8, 2009

(54) Wireless remote control for a media player connectable to a network

(75) Inventor: Yves GREGOIRE, Chatenay-Malabry (FR)

Correspondence Address: YOUNG & THOMPSON, 209 Madison Street, Suite 500, ALEXANDRIA, VA, 22314, US

(73) Assignee: ARCHOS SA, Igny (FR)

(21) Appl. No.: 12/136,788

(22) Filed: Jun. 11, 2008

(30) Foreign Application Priority Data
Jun. 13, 2007 (FR) 07/04214

(51) Int. Cl. G05B 19/02

(52) U.S. Cl. 340/825.22

(57) ABSTRACT

A device for remotely controlling functions of a digital multimedia player-recorder that is connectable to a network, and a system in which the device is implemented

The present invention relates to a device for remotely controlling a digital multimedia player-recorder that is connectable to a network. The invention also relates to the system formed by the device of the invention, to the appliance that receives and makes use of the signals transmitted by the device, and to means for playing back sound and/or a 2D and/or a 3D image.

In this period of digital convergence, the technical platforms implemented in digital audiovisual equipment are similar to those implemented in microcomputers. In addition, digital audiovisual equipment is advantageously connected directly or indirectly to a network such as the Internet (World Wide Web), constituting simultaneously a potential source for audio and/or video programs, and for electronic program guide (EPG) information, means for accessing content servers and/or dedicated services, and also for accessing generic services such as Internet browsing, email, updating on-board software, etc.

Internet sites are becoming ever richer in graphical information and in video content. In parallel, large-sized flat screens capable of high-definition display are becoming more and more widespread. Given that audiovisual equipment is traditionally easier to use than a computer, it is the preferred means for making the new digital convergence services available to consumers.

The wireless remote controls in the state of the art are not ergonomic in satisfactory manner for these new services. In general they emphasize compactness and resemblance to conventional audiovisual remote controls, over which they provide only marginal improvement.

Solutions such as those described in US 2006/0080710 or US 2005/0162569 are known that provide a minimal keyboard in addition to the functions of traditional audiovisual remote controls. Such a solution can suffice when the need for inputting alphanumeric characters is marginal, but encounters its limits very quickly e.g. when it comes to answering an email, inputting an Internet site address, or inputting the title of a work to be searched for by a search engine.

Solutions are known such as those described in U.S. Pat. No. 5,903,259, which associates traditional audiovisual remote control functions with a standard alphanumeric keyboard that forms part of a computer. That solution can be suitable when the need to input alphanumeric characters is necessary, but it is not satisfactory from an ergonomic point of view since the size of the remote control is that of a standard computer keyboard so it needs to be held on a support in order to be able to be used. The appliance described in US 2005/0025550 provides the additional refinement of being capable of physically separating the remote control from the alphanumeric keyboard. The keyboard still requires a support in order to be able to be used.

The solution proposed in WO 99/62287 associates audiovisual remote control functions on a first cover element with an alphanumeric keyboard on a second element. Those two elements are connected together so as to be folded one on the other in a closed position, thus enabling the appliance to be used in one hand only. In that configuration, the keyboard is accessible only when the appliance is in its open position, which means that it is not possible to use both portions simultaneously. That kind of utilization interferes with ease of use, particularly when browsing on the Internet requires site addresses to be keyed in, or when using email, or browsing within a page, with this all taking place practically simultaneously.

Solutions in the prior art thus provide responses to the problem that are incomplete and unsatisfactory, and that do not enable use to take place under conditions of comfort that are sufficient to enable the functional potential of new technical platforms and the associated services to be used to the full.

The invention seeks to provide a satisfactorily ergonomic solution to all of the applications that can be proposed on a digital platform capable of playing and recording digital content and that can also be connected to a network.

The term “connection to a network” is used to cover any connection to a local or infrastructure network that enables local resources to be shared, e.g. audio and/or video contents stored in one or more computers, and/or access to remote resources such as content servers and/or external services. This can apply for example to equipments connected to the Internet indirectly via connection to a gateway with an infrastructure network, e.g. a connection to an ASDL or optical fiber “box”, using an Ethernet or a WiFi connection.

In certain variant embodiments, the remotely controlled equipment may also be connected directly to an infrastructure network, such as a Wimax, HSDPA, HSUPA, HSOPA, etc. networks, for example.

“Wireless remote control” is used to mean making use of a connection, in at least one direction, that does not require a wire medium between the remote control and the electronic appliance that carries out the commands it receives remotely.

The wireless connection may be of any type without going beyond the ambit of the invention, for example it may be an infrared or ultrasound or radio frequency connection, e.g. using the ISM band with an industry standard such as ZigBee or a proprietary standard or indeed in a frequency band associated with a given protocol such as WiFi, Bluetooth, etc.

The remote control device of the invention uses a wireless connection for remotely controlling functions of a digital multimedia player-recorder that is connectable to a network. The device comprises:
at least one means for moving within a set of choices;
at least one means for validating a choice in a set of choices;
at least one means for moving a pointer over the surface of a screen or in a 3D playback space;
at least one means for performing actions associated with a pointer; and an alphanumeric keyboard having one letter per key, at least for ordinary, non-accented letters of a given character set.

The at least one means for moving within a set of choices comprises at least one dedicated key. It comprises at least one means for scanning through a set of choices proposed for a display device attached to or forming part of the controlled equipment.

For example this may be a single button on which a first press causes a set of possible choices to appear on the screen, e.g. as a menu, each press moving onto the following choice, with the choice that can be selected at a given instant being the only choice to be displayed or being distinguishable from the other displayed choices by some visible difference. After a substantially determined period of inactivity, the specific display relating to making a choice disappears. Naturally, it is possible to enrich the device by using a plurality of buttons for navigating with greater comfort through choice space, two buttons for scanning through choices presented in lists, four buttons for scanning more directly through uniform choices presented in matrices, or through non-uniform choices, or indeed for traversing tree structures. Means such as a joystick, a touch-sensitive surface, etc. can also be used for moving through a set of choices without going beyond the ambit of the invention.

The device of the invention includes at least one means for confirming one choice from amongst a proposed plurality. In a variant embodiment relying on a small number of commands, e.g. only one button for scanning through a set of choices and the same button for validating one of the proposed choices, the invention provides for using time as a variable for distinguishing between commands. For example, when the user moves through the set of choices as described above, moving from one choice to the next takes place on the button being released. When positioned on a given choice, holding the button pressed down beyond a substantially determined length of time serves to validate or enter that choice, Exit from the choice procedure and a return back to a choice that has already been made are advantageously included amongst the choices made available at all stages of the procedure. Naturally, it is advantageous to propose a dedicated command for validation purposes, and if possible another for a cancel command.

In a particularly preferred variant embodiment, movement through sets of choices, validating these choices, or canceling them relies on four keys or a “directional cross” having four contacts with a central button that is dedicated to validation purposes.

The at least one means for moving a pointer over the surface of a screen or in a 3D playback space can rely on individual contacts which, on being actuated, cause different commands to be transmitted that are interpreted by the appliance that receives them as commands for moving the pointer in a chosen direction. In order to describe a surface, four contacts can suffice. Nevertheless, use is made more comfortable by increasing the number of intermediate contacts between the main four directions. In a preferred embodiment of the invention, a compromise of eight physical contacts with processing of simultaneous presses on adjacent contacts gives a satisfactory feel that is practically analog and continuous. Processing simultaneous presses on adjacent contacts consists in managing different coding that simulates a virtual intermediate contact when two adjacent contacts are pressed simultaneously.

Naturally, a pointer device having a sensor that is naturally an analog sensor, such as a touch-sensitive pad based on capacitive or resistive detection, or indeed a discrete detection solution having greater angular resolution, enable the invention to be implemented in a manner that is even comfortable in use.

The at least one means for performing actions relating to a pointer are designed to provide functions analogous to those of traditional pointer devices such as a mouse, a trackball, a digital pad, etc. by means of the remote control device. For example this may involve reproducing the following functions: “right click”; “left click”; and latching the pointer starting from its position at the instant the command is executed.

An alphanumeric keyboard having only one letter per key, at least for ordinary letters without accents in a given character set is a characteristic of the invention that is important, insofar as it seeks to provide a satisfactory ergonomic solution concerning inputting text-based content with means that are compact and inexpensive. Most small-sized alphanumeric input means in the prior art, such as telephones, organize a keypad in which the number of keys is minimized. Such prior art solutions allocate a plurality of letters to at least some of the keys. Thus not only is the user faced with a key layout other than one with which the user is familiar, e.g. Qwerty or Azerty, but the user needs to press the keys more often in order to achieve given input compared with a solution involving a keyboard offering at least one key per ordinary letter of a given character set. Naturally, the greater the number of dedicated keys, e.g. for letters with accents or commonly used punctuation symbols, the greater the comfort in use. A satisfactory compromise is a keyboard that provides a key for each unaccented letter for example in the so-called International Latin Character Set, each key being positioned within the keyboard substantially in the traditional manner, e.g. in three rows in the QWERTY order. All or some of the accented characters, punctuation signs, or common symbols are advantageously made available as alternative meanings for keys that are allocated mainly and by default to an ordinary letter.

The invention provides for at least one key of the keyboard to have a plurality of meanings. Provision is also made for the meaning associated with at least one key to be determined by a prior action of the user on the device. For example, at least one set of alternative characters may be proposed by previously pressing on a key associated with selecting that set. The usual case-shift commands are also advantageously proposed. This may involve, for example, making a key available for inverting a temporary upper case/lower case state and/or a key for causing this state to change and be maintained. In an advantageous embodiment of the invention, the current state of certain parameters such as upper case/lower case or insert/replace are indicated by pictograms on the screen.

Variant embodiments can automatically determine the meaning associated with at least one key from an application context. For example, the keys “plus” and “minus” in an audio and/or video playback application context control sound volume, but can also mean the “plus” and the “minus” character in an application context involving inputting alphanumeric characters. Similarly, digit keys allocated to direct channel selection or to numerical values in certain application contexts may represent inputting a corresponding character in an input context.

Certain variant embodiments of the invention may include a position detector. Such a sensor may be constituted at least by a simple ball contact enabling a distinction to be made between the device being in a vertical or a horizontal orientation, for example. It is thus possible to distinguish automatically between the effects of a command by orienting the device before pressing on a key. For example, the keys allocated to digits and/or “plus” and “minus” characters in a horizontal use dedicated to inputting alphanumeric characters can become digits for changing channel or keys for changing sound level merely by changing orientation before pressing on the key.

For a remote control device that is usable in a plurality of orientations and that transmits its commands by infrared, it is advantageous or even essential to include at least one emitter that emits towards the receiver in each utilization position. It is also possible to implement an optical reflector arranged to direct the infrared signals from a single emitter or from a single group of emitters in the directions of interest relative to the possible orientations of the device.

In certain variants of the invention, means are implemented for visually showing the expected meaning in the event of pressing on a key that has multiple potential meanings. This meaning is shown to the user automatically as a function of a context. The context may be the orientation of the device. For example, simple marking that is readable preferentially as a function of the orientation of the device can be suitable. In a more sophisticated embodiment, provision can be made to use polarizers for making the appropriate marking visible in a given orientation.

In a more sophisticated embodiment, display means are used that present very low energy consumption and that are very inexpensive, e.g. display means based on light-emitting inks or indeed so-called “electronic paper”. Such display means are controlled by electronics within the device of the invention, advantageously in association with an information return channel coming back from the remotely-controlled appliance, and they enable the meaning associated with at least some of the keys of the device to be seen as a function of the application context.

When several sets of alternative characters are made available on all or some of the keys of the keyboard, the keyboard can be made more ergonomic by using different colors associating the key for selecting one of the sets of alternative characters with the marking of the associated alternative characters on the keys. Associating alternative meanings for keys with the key for selecting a given alternative set of meanings can also rely on where the corresponding marking is located, for example marking in the left corner or the right corner of the key. If the surface area of a key is large enough to add additional markings that remain legible, then additional sets of characters may be made available, e.g. to offer optionally accented letters that are specific to certain languages. On keys presenting a certain amount of height, the front face of a key, if slightly sloping, can also received marking for alternative characters. The meanings of keys are traditionally marked on the top faces of those keys, however it would not go beyond the ambit of the invention for all or some of the marking relating to the keys of the keyboard to be made on portions thereof that are situated between keys, where appropriate.

The disposition of the invention may also advantageously include at least one command associated with an audiovisual application. This might be a command for controlling sound playback volume, or a mute command, or a command for activating an external screen, etc. In a highly advantageous variant embodiment of the invention, the keys of the keyboard that are normally provided for inputting alphanumeric characters in contexts that require them, such as in an email application for example, are reallocated to directly selecting program sources in an application context that is purely audiovisual. Selection of program sources is said to be “direct” when a given audio and/or video program source by means of a command. The source previously allocated by the user to a determined key of the device of the invention can be thought of as a TV channel, a radio station, a continuous source of information in text mode, etc. In a system of the invention, program sources are potentially very numerous and the user can have a mixed variety of preferred sources for recurrent interests. For example, the user may have several preferred traditional television channels coming from a “set-top box” or a tuner that is external to the multimedia digital player-recorder, and/or preferred radio stations coming from a radio tuner. However the user may also have preferred “channels” or “stations” respectively for “television” or “radio” that are of general interest or of specialized interest coming from the Internet and accessible via a connection to a network. The technical means whereby a program is broadcast or accessed is no longer a pertinent criterion for selection as such. The invention provides for giving substantially direct access to preferred programs or programs of interest in order to play them back by external means, which programs may come potentially from any type of source, including local recording means used on the principle of a “podcast” as applies to radio and/or video.

One of the essential characteristics of the invention is that it is constituted by a remote control, i.e. by a self-contained device of size that is capable of being held in one hand.

A preferred variant embodiment of the invention is arranged to be held in both hands, with the keys being reachable by one and/or the other of the thumbs. This variant is particularly ergonomic in that the article is held in natural manner between the two “notches” formed by the join between the thumb and the forefinger of each hand. In this position, access to the keys or to other control means of the device takes place in natural and comfortable manner by means of one or the other of the thumbs. This variant enables the device to be held firmly and stably, even while moving about, and is well adapted to the function of the device and can be suited to users of all ages. Naturally, it would not go beyond the ambit of the invention if a device that is optimized for being held in both hands and manipulated with the thumbs were to be held in one hand only and be manipulated with fingers other than a thumb.

A self-contained appliance such as a device of the invention has its own optionally rechargeable power supply. In general, in prior art remote controls the power supply comprises at least two batteries connected in series, which batteries are conventionally housed in a common compartment one behind the other or side by side. In the invention, provision is made for these generally bulky components to be kept apart. These elements are separated and housed where appropriate in separate housings so as to provide advantages such as reducing the thickness of the device in the zones where it is held in use, creating stable bearing points to enable the device to be put down, creating setback zones in its thickness for making it easier to grasp when placed on a support, for distributing weights, for guiding fingers to grasp the device more reliably, . . . .

The embodiment of the invention as described above makes use of physically distinct means for moving through a set of choices and for moving a pointer on the surface of a screen or in a 3D playback space. In certain variant embodiments of the invention it is possible to “factorize” means so as to make the device more compact without significantly making it less ergonomic. There is similarity between means for moving over a surface or in a volume and means for moving through a choice space. This is essentially a problem of managing the context and the effect of the commands that are transmitted, and the means from which the commands originate in the device of the invention can be common, at least in part.

By way of example these may be means for determining a direction in which it is appropriate to move the pointer in a given application. These means may be based for example on a plurality of digital contacts, possibly associated with processing logic to create virtual intermediate contacts. By way of example these means may equally well be a joystick or a digital pad. Means are provided for going from using the common means to move a pointer on a surface or in a volume, to using the common means for moving in a choice space. Such means may be a single button having two mechanically-stable states that are visible, or it could equally well be a change-of-context pushbutton for alternating the mode of the navigation means, or indeed two pushbuttons, each being dedicated to one given type of use and identified as such by appropriate marking. A memory associated with such buttons having mutually exclusive effects conserves the mode of utilizing the common means that corresponds to the most recent button on which the user has pressed.

As described above for the navigation means, the commands associated with each type of use of the means that are common can likewise be factorized. Provision is made in the invention for the effects of these additional control means to change appropriately with the use of the associated navigation means. For example, the three buttons having the following means “left click”, “right click”, and “docking” in a context of navigating on a surface or in a volume are reassigned to the following means: “OK”, “cancel”, and “menu”, in a context of navigating through a set of choices.

Without going beyond the ambit of the invention, it is equally possible to make use of functional refinements as described in the following non-limiting list.

A “menu” key on which a press automatically positions the common navigation means in navigation mode in a set of choices.

A docking key can be used cyclically to dock the pointer to its current position, to select a text or graphics object associated with the position of the pointer, and optionally to pass automatically to the mode for navigating through a set of choices amongst a plurality of objects represented by the text and/or plane graphics elements, or in a volume.

The device of the invention is used in a system that comprises at least:
a wireless remote control device;
a digital multimedia player-recorder that is connectable to a network;
means for playing back sound and/or still and/or moving images in 2D and/or in 3D.

Other advantages and characteristics of the invention appear on examining the following detailed description of a non-limiting embodiment, and the accompanying drawings, in which:

FIG. 1 shows an embodiment of the device of the invention;

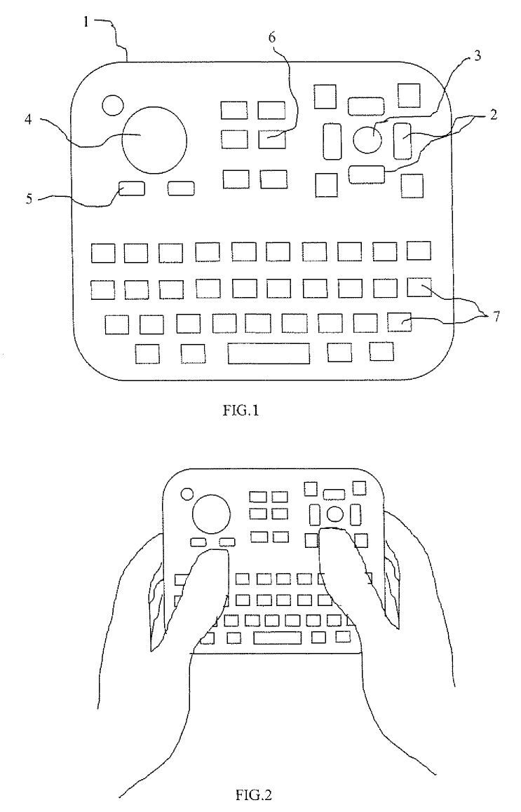

FIG. 2 shows a typical manner of holding the remote control device;

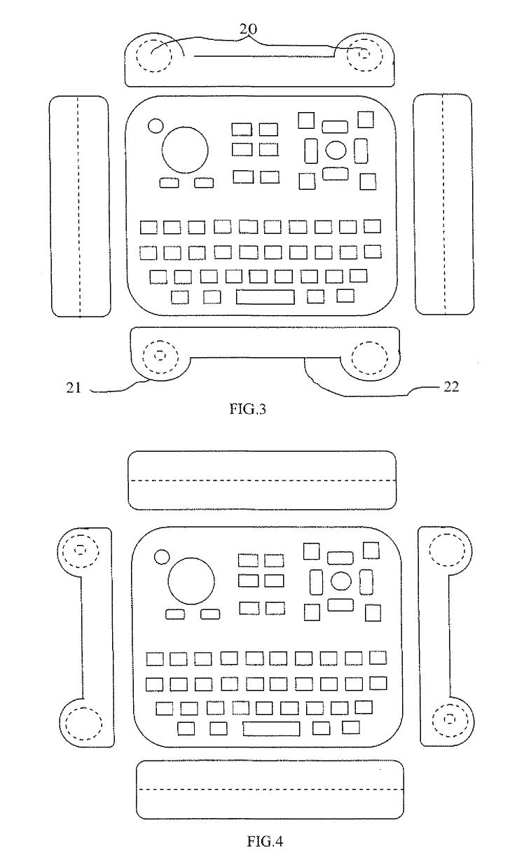

FIG. 3 shows an attractive and mechanical embodiment that takes advantage of bulky components being kept apart in accordance with the invention;

FIG. 4 shows another variant of keeping components apart;

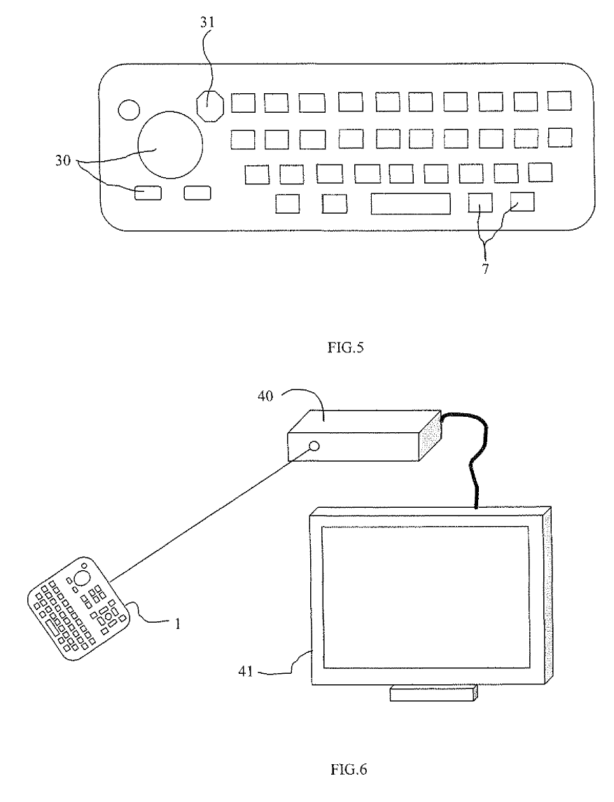

FIG. 5 shows another variant embodiment of the remote control of the invention; and

FIG. 6 shows the system within which the remote control device of the invention is used.

### DETAILED DESCRIPTION OF THE FIGURES

FIG. 1 shows a remote control device 1 of the invention.

The following characteristic elements can be seen therein:
means 2 for moving within a set of choices;
means 3 for validating a choice in a set of choices;
means 4 for moving a pointer over the surface of a screen or in a 3D playback space;
means 5 for performing actions associated with a pointer;
an alphanumeric keyboard 7 having one letter per key, at least for ordinary, non-accented letters in a given character set.
   The key 6 is a command associated with an audiovisual application.

FIG. 2 shows a preferred type of use of the remote control device of the invention. The device is held securely between the two notches constituted by the join between the thumb and the forefinger of each hand. In this comfortable position the thumbs can reach the various keys and commands of the device without effort.

FIG. 3 shows the beneficial effect of spacing apart bulky components, in this case batteries 20. This makes it possible to create support zones 21 and grip zones 22 that contribute to making the device more ergonomic.

FIG. 4 shows a variant configuration on the same inventive principle.

FIG. 5 shows an embodiment of the invention in which the navigation means 30 and the associated action means are used in common for describing a surface or a volume and for describing a choice space. A command 31 makes it possible to switch from one mode to the other. This type of format lends itself well to operation making use of the orientation that is traditional in the context of audiovisual applications, together with a horizontal orientation for applications that require text to be input with a keyboard 7. Switching from one mode to the other may be implicit, with both orientations being simultaneously in operation. Orientation can also be optimized in one orientation or the other by making a manual selection using appropriate command means, or orientation can be detected automatically by an in-built sensor.

FIG. 6 shows a typical system implementing the remote control device of the invention. There can be seen the remote control 1, a digital multimedia player-recorder 40, and image and sound playback means, in this example a simple TV set.

Naturally, the invention is not limited to the embodiments described above, and numerous variations can be provided, other combinations of characteristics and/or use can be provided without going beyond the ambit of the invention. Furthermore, the above-mentioned examples of solutions or technical standards are those that are in force at the time the patent application was filed. They might well change or be rapidly replaced by others without that making the invention itself obsolete.

1-16. (canceled)

17. A one-piece remote control device of size suitable for being held in one hand, using a wireless connection for remotely controlling functions of a digital multimedia player-recorder that is connectable to a network, the device being characterized in that it comprises:
at least one means (2) for moving within a set of choices;
at least one means (3) for validating a choice in a set of choices;
at least one means (4) for moving a pointer over the surface of a screen or in a 3D playback space;
at least one means (5) for performing actions associated with a pointer; and
an alphanumeric keyboard (7) having one letter per key, at least for ordinary, non-accented letters of a given character set.

18. A device according to claim 17, further comprising at least one command (6) associated with an audiovisual application.

19. A device according to claim 17, wherein it is arranged to be held in both hands with keys that can be reached by one and/or the other thumb.

20. A device according to claim 17, wherein all or some of the bulky components (20) incorporated therein are spaced apart.

21. A device according to claim 17, further comprising a position detector.

22. A device according to claim 17, wherein the means for moving in a set of choices comprise at least one dedicated key.

23. A device according to claim 17, wherein the means for moving in a set of choices and the means for moving a pointer on the surface of a screen or in a 3D playback space physically coincide, at least in part.

24. A device according to claim 17, wherein the means for validating a choice in a set of choices, and the means for taking actions associated with a pointer coincide physically, at least in part.

25. A device according to claim 17, wherein at least one keyboard key has a plurality of meanings.

26. A device according to claim 25, wherein the meaning associated with at least one key is determined by a prior action of the user on the device.

27. A device according to claim 25, wherein the meaning associated with at least one key is determined by an application context.

28. A device according to claim 25, wherein the meaning associated with at least one key is determined by the position of the device.

29. A device according to claim 25, further comprising means for visually showing the expected meaning in the event of pressing on a key that has multiple potential meanings.

30. A device according to claim 29, wherein the expected meaning is automatically visually shown by the means as function of a context.

31. A device according to claim 30, wherein the context is the orientation of the device.

32. A remote control system comprising:
a wireless remote control device;
a digital multimedia player-recorded that is connectable to a network; and
means for playing back sound and/or still and/or animated images in 2D and/or in 3D.
